(19) United States
(12) Patent Application Publication
(10) Pub. No.: US 2014/0037263 A1
(43) Pub. Date: Feb. 6, 2014

(54) VIDEO AND DATA COLLECTION AND DISPLAY SYSTEM

(71) Applicant: Thomas Stanley Sunderland, III, Warner Robins, GA (US)

(72) Inventor: Thomas Stanley Sunderland, III, Warner Robins, GA (US)

(21) Appl. No.: 13/959,244

(22) Filed: Aug. 5, 2013

Related U.S. Application Data
(60) Provisional application No. 61/679,604, filed on Aug. 3, 2012.

(51) Int. Cl. H04N 9/79

(52) U.S. Cl. CPC H04N 9/79
USPC 386/227

(57) ABSTRACT

A device and system for overlaying information taken during a video stream. The device may include a speedometer, a global positioning system, and a computer. The information may include the location of the video stream, and the velocity of the device. In certain embodiments, the data and video may be collected prior to the merge of the video and data or simultaneously with the merge of the video and data. A computer may be used to merge the video and data and the video may be watched with the data overlaid and thereby displayed to the user.

### CROSS-REFERENCE TO RELATED APPLICATION

This application claims the benefit of priority of U.S. provisional application No. 61/679,604, filed Aug. 3, 2012, the contents of which are herein incorporated by reference.

### BACKGROUND OF THE INVENTION

The present invention relates to a video and data collection and display system and, more particularly, to a video recording merged with at least one of a velocity and global positioning system coordinates.

A video camera is a camera used for motion picture acquisition, initially developed by the television industry but now common in other applications as well. Recorded video is used in television and film production and more often surveillance and monitoring tasks where unattended recording of a situation is required for later analysis. Currently, a video camera may capture streaming video which may be displayed at a later time. Certain information may be overlaid on the video display, such as the day and time of the recording. However, occasionally additional information about the recording is needed.

As can be seen, there is a need for a recording system that displays further characteristics of the recorded video.

### SUMMARY OF THE INVENTION

In one aspect of the present invention, a video recording device comprises: a computer comprising memory; a video recording component; a speedometer; and an activation component, wherein when the activation component is activated, the video recording component records video creating a video recording and the speedometer records the velocity of the video recording device creating a velocity recording, wherein the video recording and the velocity recording are stored onto the memory of the computer, wherein the velocity recording is overlaid onto the video recording creating a video and velocity recording.

In another aspect of the present invention, a system for displaying a video stream comprises: a computer operatively connected to a video recorder and a speedometer; and a program product comprising machine-readable program code for causing, when executed, the computer to perform the following process steps: recording a video recording; recording a velocity recording simultaneously with the video recording; and overlaying the velocity recording onto the video recording creating a video and velocity recording.

These and other features, aspects and advantages of the present invention will become better understood with reference to the following drawings, description and claims.

### BRIEF DESCRIPTION OF THE DRAWINGS

FIG. 1 is a flowchart of the present invention; and

FIG. 2 is a schematic view of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a device and system for overlaying information taken during a video stream. The device may include a speedometer, a global positioning system, and a computer. The information may include the location of the video stream, and the velocity of the device. In certain embodiments, the data and video may be collected prior to the merge of the video and data or simultaneously with the merge of the video and data. A computer may be used to merge the video and data and the video may be watched with the data overlaid and thereby displayed to the user.

The present invention may include at least one computer with a user interface. The computer may include any device with a microprocessor such as, but not limited to, a desktop, laptop, video camera, and smart device, such as, a tablet and smart phone. The computer may include a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

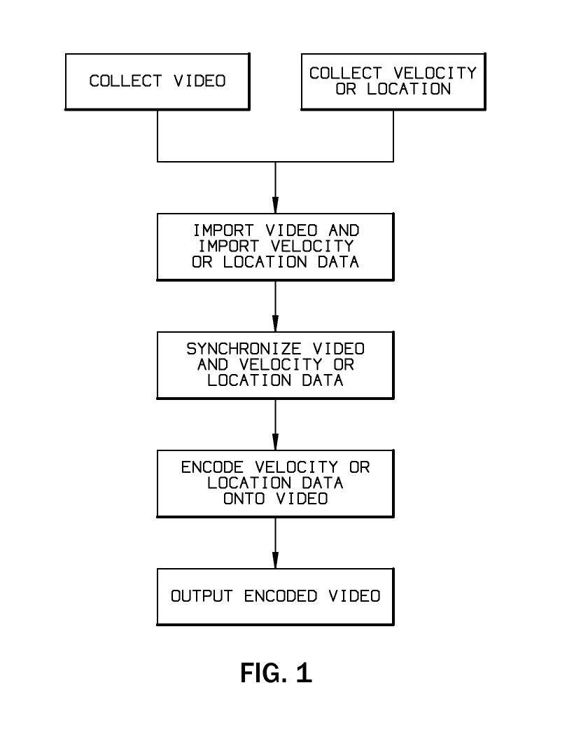

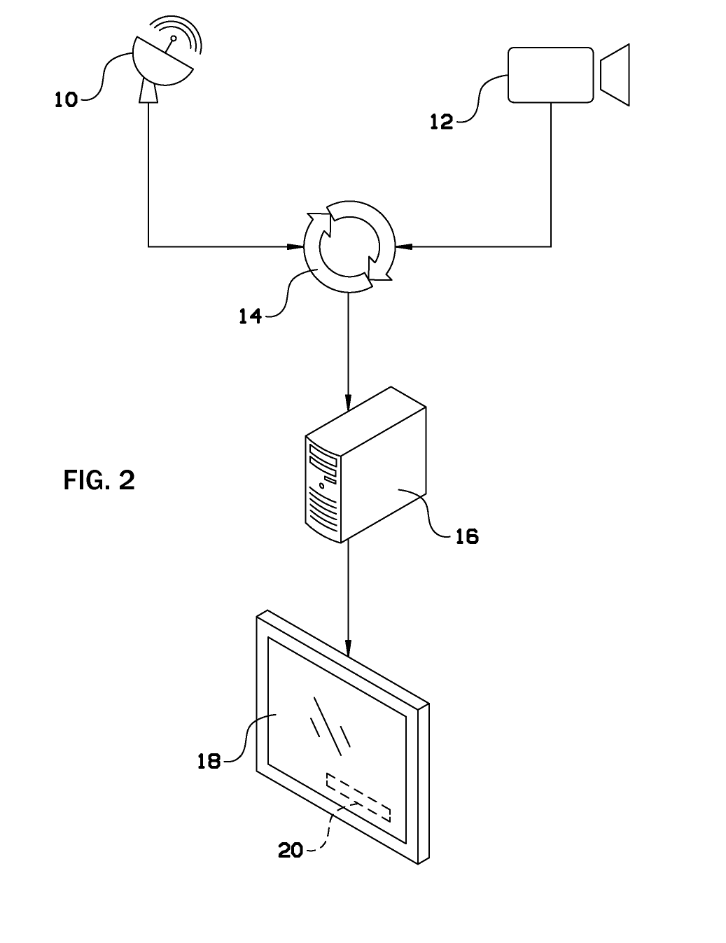

Referring to FIGS. 1 and 2, the present invention may include a recording system. The recording system may include a video recorder 12 and a data collector 10. In certain embodiments, the data collector 10 may include a global positioning system, a speedometer, and the like. An activation component may be operatively connected to the video recorder 12 and the data collector 10. When the activation component is activated the video recorder 12 may take video recordings and the data collector may collect data. For example, if the data collector 10 is a global position system the data collector may record global positioning system coordinates and if the data collector 10 is a speedometer, the data collector 10 may record the velocity of the recording system.

In certain embodiments, the present invention may include a computer 16 having a memory. The data recordings and the video recordings may be imported and stored on the computer 16. In certain embodiments, the computer 16 may synchronize and overlay 14 the data recordings and the video recordings. The computer may then display the overlaid data and video recordings on a display device 18, displaying the streaming video and the data 20 from the data collector. For example, the data 20 projected on the display may be at least one of the global positioning coordinates and the velocity recorded.

The present invention may further include a system including a computer, a video recorder, and a data collector. The system may further include a program product having machine-readable program code for causing, when executed, the computer to perform process steps. As mentioned above, the data collector may include a global positioning system, a speedometer, and the like. The video recorder may record or collect a video recording. The data collector may record or collect data, including, but not limited to, a velocity recording, a global positioning recording and the like. In certain embodiments, the data collector and video recorder may record and collect data simultaneously. The data and the video may be imported to a computer system. The video and the data may be overlaid by synchronizing and encoding. The encoded video may be displayed on a display device. For example, the video with global positioning coordinates and/or velocity may be displayed.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A video recording device comprising:
a computer comprising memory;
a video recording component;
a speedometer; and
an activation component, wherein when the activation component is activated, the video recording component records video creating a video recording and the speedometer records the velocity of the video recording device creating a velocity recording,
wherein the video recording and the velocity recording are stored onto the memory of the computer,
wherein the velocity recording is overlaid onto the video recording creating a video and velocity recording.

2. The video recording device of claim 1, further comprising a global positioning system, wherein when the activation component is activated, the global position system records the global position system coordinates of the video recording device creating a global positioning system coordinates recording, wherein the global positioning system coordinates recording is stored onto the memory of the computer, wherein the global positioning system coordinates are overlaid onto the video recording by the computer.

3. The video recording device of claim 1, further comprising a display device for displaying the video and velocity recording.

4. A system for displaying a video stream comprising:
a computer operatively connected to a video recorder and a speedometer; and
a program product comprising machine-readable program code for causing, when executed, the computer to perform the following process steps:
recording a video recording;
recording a velocity recording simultaneously with the video recording; and
overlaying the velocity recording onto the video recording creating a video and velocity recording.

5. The system of claim 4, further comprising the step of importing the video recording and the velocity recording to the computer.

6. The system of claim 5, further comprising the step of synchronizing the video recording and the velocity recording.

7. The system of claim 4, further comprising the step of displaying the video recording and velocity recording on a display.

8. The system of claim 4, wherein the computer is operatively connected to a global positioning system.

9. The system of claim 8, further comprising the steps of:
recording a global positioning system coordinates recording simultaneously with the video recording; and
overlaying the global positioning system coordinates recording onto the video recording creating a video, coordinates, and velocity recording.

10. The system of claim 9, further comprising the step of displaying the video, coordinates, and velocity recording on a display.
